(19) United States
(12) Patent Application Publication
(10) Pub. No.: US 2008/0224760 A1
(43) Pub. Date: Sep. 18, 2008

(54) REFERENCE VOLTAGE GENERATOR AND INTEGRATED CIRCUIT INCLUDING A REFERENCE VOLTAGE GENERATOR

(75) Inventors: Dong-Uk PARK, Gyeonggi-do (KR); Nak-Shin KIM, Seoul (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 12/045,903

(22) Filed: Mar. 11, 2008

(30) Foreign Application Priority Data
Mar. 13, 2007 (KR) 2007-0024625

(51) Int. Cl. G05F 3/16

(52) U.S. Cl. 327/539; 327/543

(57) ABSTRACT

A reference voltage generator and an integrated circuit including the reference voltage generator. The reference voltage generator includes a band gap reference circuit and a start-up circuit. The band gap reference circuit provides a reference voltage to a load. The start-up circuit increases the provided reference voltage by providing a boosting current to the load based on a difference between the provided reference voltage and a target reference voltage responsive to a start-up signal, thereby reducing a time in which the provided reference voltage reaches the target reference voltage. Therefore, the reference voltage generator is configured to provide a target reference voltage within a predetermined time.

### CROSS-REFERENCE TO RELATED APPLICATION

This application claims priority under 35 USC §119 to Korean Patent Application No. 2007-24625, filed on Mar. 13, 2007 in the Korean Intellectual Property Office (KIPO), the contents of which are incorporated herein by reference.

### BACKGROUND OF THE INVENTION

1. Field of the Invention

Embodiments of the present invention relate to a reference voltage generator and an integrated circuit including the reference voltage generator. More particularly, embodiments of the present invention relate to a reference voltage generator capable of generating a target reference voltage within a predetermined time and an integrated circuit including the reference voltage generator.

2. Description of the Related Art

In 1971, Robert Widlar introduced a band gap reference (BGR) circuit. The BGR circuit is an analog circuit providing a constant voltage independently of environmental factors such as a power supply voltage, a temperature, a manufacturing process, etc. The BGR circuit may be employed in an application requiring a constant bias voltage.

As an operation speed of a semiconductor device increases, the semiconductor device is designed to attain a normal condition within a short time while booting the semiconductor device or while changing an operation mode of the semiconductor device. A constant reference voltage should quickly be provided by the BGR circuit so that the semiconductor device normally operates within a predetermined time.

FIG. 1 is a block diagram illustrating a conventional BGR circuit, and FIG. 2 is a graph illustrating a reference voltage provided by the conventional BGR circuit illustrated in FIG. 1.

Referring to FIGS. 1 and 2, a conventional BGR circuit 110 is coupled to a load 120, such as a capacitive element. The conventional BGR circuit 110 provides the reference voltage to the load 120. In FIGS. 1 and 2, a solid line 210 represents a change of the reference voltage according to an elapse of time. The reference voltage 210 cannot reach a target reference voltage, for example about 1.2 V, even though a time of about 100 micro seconds has elapsed.

As illustrated in FIG. 2, the conventional BGR circuit 110 requires a long time for generating the target reference voltage of a desired level. Further, a system may not operate normally if the target reference voltage may be not provided within a predetermined time required in a specific application.

### SUMMARY OF THE INVENTION

Example embodiments of the present invention include a reference voltage generator configured to provide a target reference voltage within a predetermined time.

Example embodiments of the present invention include an integrated circuit having a reference voltage generator configured to provide a target reference voltage within a predetermined time.

Example embodiments of the present invention include a method of generating a target reference voltage within a predetermined time.

According to one aspect of the present invention, there is provided a reference voltage generator including a band gap reference circuit and a start-up circuit. The band gap reference circuit may provide a reference voltage to a load. The start-up circuit may increase the provided reference voltage by providing a boosting current to the load based on a difference between the provided reference voltage and a target reference voltage responsive to a start-up signal, thereby reducing a time in which the provided reference voltage reaches the target reference voltage.

In some example embodiments, the band gap reference circuit may generate the start-up signal when the difference between the provided reference voltage and the target reference voltage required by the load is larger than a predetermined value.

In some example embodiments, the band gap reference circuit may generate the start-up signal when the band gap reference circuit starts or a mode of the band gap reference circuit is changed from a sleep mode to an active mode.

In some example embodiments, the start-up circuit may form a first path for providing the boosting current to the load and a second path for sinking the boosting current, and the boosting current may flow through at least one of the first path and the second path in accordance with the difference between the provided reference voltage and the target reference voltage. The start-up circuit may apply the boosting current to the first path substantially in proportion to the difference between the provided reference voltage and the target reference voltage and to the second path substantially in reverse proportion to the difference between the provided reference voltage and the target reference voltage.

In some example embodiments, the start-up circuit may include a current source configured to generate the boosting current, a current sink configured to sink the boosting current, and a switch configured to form a first path through which the boosting current is provided to the load substantially in proportion to the difference between the provided reference voltage and the target reference voltage, and a second path through which the boosting current is sunk by the current sink substantially in reverse proportion to the difference between the provided reference voltage and the target reference voltage based on the start-up signal. The current source may include at least one first transistor having a first conductive type and the current sink may include at least one second transistor having a second conductive type. An amount of the boosting current provided to the load and an amount of the boosting current sunk by the current sink may be determined based on at least one of a number of the at least one first transistor, a size of the at least one first transistor, a number of the at least one second transistor and a size of the at least one second transistor.

In some example embodiments, the current source may include at least one PMOS transistor having a gate to which the provided reference voltage is applied and the current sink may include at least one NMOS transistor having a gate to which the provided reference voltage is applied. The current source may further include at least one diode-connected PMOS transistor serially connected to the at least one PMOS transistor. The current sink may further include at least one diode-connected NMOS transistor serially connected to the at least one NMOS transistor. An amount of the boosting current provided to the load and an amount of the boosting current sunk by the current sink may be determined based on at least one of a number of the at least one PMOS transistor, a size of the at least one PMOS transistor, a number of the at least one NMOS transistor and a size of the at least one NMOS transistor.

In some example embodiments, the reference voltage generator may further include a boosting unit generating the start-up signal based on system status information and the provided reference voltage. The system status information may include information of a point in time when the band gap reference circuit starts or on a point in time when a mode of the band gap reference circuit is changed from a sleep mode to an active mode. The boosting unit may generate the start-up signal when the difference between the provided reference voltage and the target reference voltage required by the load is larger than a predetermined value. The start-up circuit may form a first path for providing the boosting current to the load and a second path for sinking the boosting current, and the boosting current may flow through at least one of the first path and the second path in accordance with the difference between the provided reference voltage and the target reference voltage. The start-up circuit may apply the boosting current to the first path substantially in proportion to the difference between the provided reference voltage and the target reference voltage and to the second path substantially in reverse proportion to the difference between the provided reference voltage and the target reference voltage.

In some example embodiments, the start-up circuit may include a current source may generate the boosting current, a current sink may sink the boosting current, and a switch may form a first path through which the boosting current is provided to the load substantially in proportion to the difference between the provided reference voltage and the target reference voltage and a second path through which the boosting current is sunk by the current sink substantially in reverse proportion to the difference between the provided reference voltage and the target reference voltage based on the start-up signal.

According to one aspect of the present invention, there is provided an integrated circuit including a semiconductor device and a reference voltage generator. The semiconductor device may perform a specific operation based on a target reference voltage and the reference voltage generator generates the target reference voltage. The reference voltage generator may include a band gap reference circuit for providing a reference voltage to a load and a start-up circuit for increasing the provided reference voltage by providing a boosting current to the load based on a difference between the provided reference voltage and the target reference voltage responsive to a start-up signal so as to reduce a time in which the provided reference voltage reaches the target reference voltage.

In some example embodiments, the specific operation may include at least one of a comparison operation, an operation of converting a digital signal to an analog signal, an operation of converting an analog signal to a digital signal and an operation that requires a bias voltage.

In some example embodiments, the band gap reference circuit may generate the start-up signal when the difference between the provided reference voltage and the target reference voltage required by the load is larger than a predetermined value.

In some example embodiments, the band gap reference circuit may generate the start-up signal when the band gap reference circuit starts or a mode of the band gap reference circuit is changed from a sleep mode to an active mode.

In some example embodiments, the start-up circuit may form a first path for providing the boosting current to the load and a second path for sinking the boosting current, and the boosting current may flow through at least one of the first path and the second path in accordance with the difference between the provided reference voltage and the target reference voltage. The start-up circuit may apply the boosting current to the first path substantially in proportion to the difference between the provided reference voltage and the target reference voltage and to the second path substantially in reverse proportion to the difference between the provided reference voltage and the target reference voltage.

In some example embodiments, the start-up circuit may include a current source for generating the boosting current, a current sink for sinking the boosting current, and a switch for forming a first path through which the boosting current is provided to the load substantially in proportion to the difference between the provided reference voltage and the target reference voltage and a second path through which the boosting current is sunk by the current sink substantially in reverse proportion to the difference between the provided reference voltage and the target reference voltage based on the start-up signal.

In some example embodiments, the reference voltage generator may further include a boosting unit generating the start-up signal based on system status information and the provided reference voltage. The system status information may include information on when the band gap reference circuit starts or on when a mode of the band gap reference circuit is changed from a sleep mode to an active mode.

According to one aspect of the present invention, there is provided a method of generating a reference voltage. In the method of generating the reference voltage, the reference voltage may be provided to a load, and the provided reference voltage may be increased by providing a boosting current to the load based on a difference between the provided reference voltage and a target reference voltage responsive to a start-up signal so as to reduce a time in which the provided reference voltage reaches the target reference voltage.

In some example embodiments, the start-up signal may be generated when the difference between the provided reference voltage and the target reference voltage required by the load is larger than a predetermined value.

In some example embodiments, the start-up signal may be generated when the band gap reference circuit starts or a mode of the band gap reference circuit is changed from a sleep mode to an active mode.

In some example embodiments, a first path for providing the boosting current to the load and a second path for sinking the boosting current may be formed, and the boosting current may be provided through at least one of the first path and the second path in accordance with the difference between the provided reference voltage and the target reference voltage. The boosting current may be applied to the first path substantially in proportion to the difference between the provided reference voltage and the target reference voltage and to the second path substantially in reverse proportion to the difference between the provided reference voltage and the target reference voltage.

Therefore, the reference voltage generator according to some example embodiments of the present invention may provide the reference voltage having a voltage level identical to that of the target reference voltage within a predetermined time using the provided boosting current.

### BRIEF DESCRIPTION OF THE DRAWINGS

FIG. 1 is a block diagram illustrating a conventional band gap reference (BGR) circuit.

FIG. 2 is a graph illustrating a reference voltage provided from the conventional band gap reference circuit.

FIG. 3 is a circuit diagram illustrating a reference voltage generator in accordance with example embodiments of the present invention.

FIG. 4 is a graph illustrating a reference voltage provided from the reference voltage generator in FIG. 3.

FIG. 5 is a circuit diagram illustrating a reference voltage generator in accordance with example embodiments of the present invention.

FIG. 6 is a circuit diagram illustrating a reference voltage generator in accordance with example embodiments of the present invention.

FIG. 7 is a circuit diagram illustrating a reference voltage generator in accordance with example embodiments of the present invention.

FIG. 8 is a block diagram illustrating an integrated circuit including a reference voltage generator in accordance with example embodiments of the present invention.

### DETAILED DESCRIPTION OF THE EMBODIMENTS

Embodiments of the present invention now will be described more fully with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

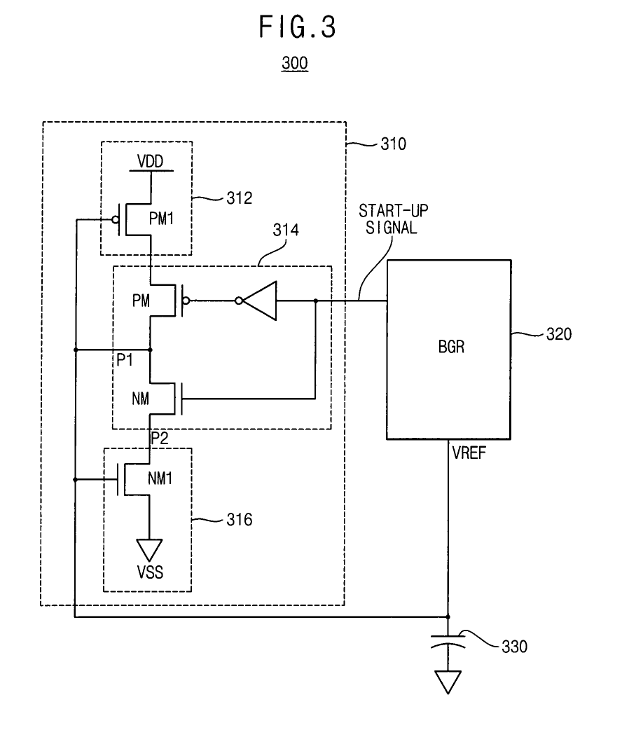

FIG. 3 is a circuit diagram illustrating a reference voltage generator in accordance with example embodiments of the present invention.

Referring to FIG. 3, a reference voltage generator 300 includes a start-up circuit 310 and a band gap reference (BGR) circuit 320. The reference voltage generator 300 may apply a reference voltage to a load 330.

In one example embodiment, the load 330 may correspond to an output load employed in the reference voltage generator 300. In another example embodiment, the load 330 may be employed in a semiconductor device to which the reference voltage is provided. As occasion demands, the load 330 may correspond to a device having a relatively low capacity.

The BGR circuit 320 may supply the reference voltage to the load 330. When the load 330 has a relatively large value (e.g., a relatively large capacitance), the conventional BGR circuit needs considerably more time for generating a reference voltage having a voltage level identical to that of a target reference voltage. However, according to the present invention, the BGR circuit 320 may provide a start-up signal to the start-up circuit 310 so that the reference voltage may rapidly reach the target reference voltage.

In some example embodiments, the BGR circuit 320 may generate the start-up signal when a voltage difference between the reference voltage and the target reference voltage is larger than a predetermined value.

In other example embodiments, the BGR circuit 320 may generate the start-up signal when the BGR circuit 320 starts or when a mode of the BGR circuit 320 is changed from a sleep mode to an active mode.

To reduce a time for the reference voltage provided from the BGR circuit 320 to approach the target reference voltage, the start-up circuit 310 may provide a boosting current into the load 330 substantially in proportion to the voltage difference between the reference voltage and the target reference voltage based on the start-up signal so that the start-up circuit 310 may contribute to increase the reference voltage provided from the BGR circuit 320.

The start-up circuit 310 may provide a first path P1 and a second path P2 for the boosting current. For example, the boosting current may be provided by the start-up circuit 310 into the load 330 through the first path P1. Further, the start-up circuit 310 may provide the boosting current into a current sink 316 through the second path P2. That is, the boosting current may be provided from the start-up circuit 310 through at least one of the first path PI and the second path P2 in accordance with the difference between the reference voltage provided from the BGR circuit 320 and the target reference voltage.

In some example embodiments, the boosting current may be provided into the load 330 only while the start-up signal is activated. Hence, the first path P1 for transferring the boosting current may be floated when the start-up signal is not activated.

The start-up circuit 310 may provide some portion of the boosting current through the first path P1 substantially in proportion to the difference between the reference voltage provided from the BGR circuit 320 and the target reference voltage, whereas the start-up circuit 310 may provide another portion of the boosting current through the second path P2 substantially in reverse proportion to the difference between the reference voltage provided from the BGR circuit 320 and the target reference voltage. When the difference between the reference voltage provided from the BGR circuit 320 and the target reference voltage is relatively large, the start-up circuit 310 may mainly provide the boosting current through the first path P1 rather than the second path P2. Conversely, the start-up circuit 310 may mainly provide the boosting current through the second path P2 rather than the first path P1 when the difference between the reference voltage provided from the BGR circuit 320 and the target reference voltage is relatively small.

In some example embodiments, the start-up circuit 310 includes a current source 312, a switch 314 and a current sink 316.

The switch 314 may form the first path P1 and/or the second path P2 for transferring the boosting current into the load 330 and/or the current sink 316 based on the start-up signal generated from the BGR circuit 320. The boosting current may be provided to the load 330 and the current sink 316 through the first path P1 and the second path P2, respectively. In example embodiments, the switch 314 may include a transistor having a first conductive type or a transistor having a second conductive type.

The current source 312 may generate the boosting current. The boosting current generated by the current source 312 may be provided to the load 330 substantially in proportion to the difference between the reference voltage and the target reference voltage. The current source 312 may include at least one transistor having the first conductive type. In some example embodiments, the current source 312 may include a P-type Metal Oxide Semiconductor (PMOS) transistor PM1 coupled to a power supply voltage VDD.

The current sink 316 may sink the boosting current into a ground voltage VSS substantially in reverse proportion to the difference between the reference voltage and the target reference voltage. The current sink 316 may include at least one transistor having the second conductive type. In some example embodiments, the current sink 316 may include an N-type Metal Oxide Semiconductor (NMOS) transistor NM1 coupled to a ground voltage VSS.

The current source 312 and the current sink 316 may increase the boosting current provided to the load 330 when the difference between the reference voltage and the target reference voltage is relatively large, and may decrease the boosting current provided to the load 330 when the difference between the reference voltage and the target reference voltage is relatively small.

In some example embodiments, the start-up circuit 310 may determine an amount of the boosting current provided to the load 330 and an amount of the boosting current sunk by the current sink 316 based on a size of the PMOS transistor PM1 and a size of the NMOS transistor NM1. If the size of the PMOS transistor PM1 is twice as large as the size of the NMOS transistor NM1, the target reference voltage may correspond to a half of the power supply voltage VDD. Accordingly, as the reference voltage reach the half of the power supply voltage VDD, the boosting current provided to the load 330 may decrease and the boosting current provided to the current sink 316 may increase.

Alternatively, in some example embodiments, the transistors included in the current source 312, the switch 314 and the current sink 316 may be arranged in many different forms.

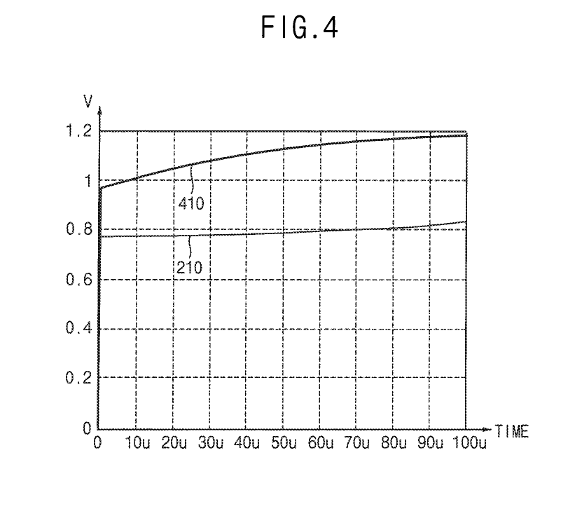

FIG. 4 is a graph illustrating a reference voltage provided from the reference voltage generator in FIG. 3.

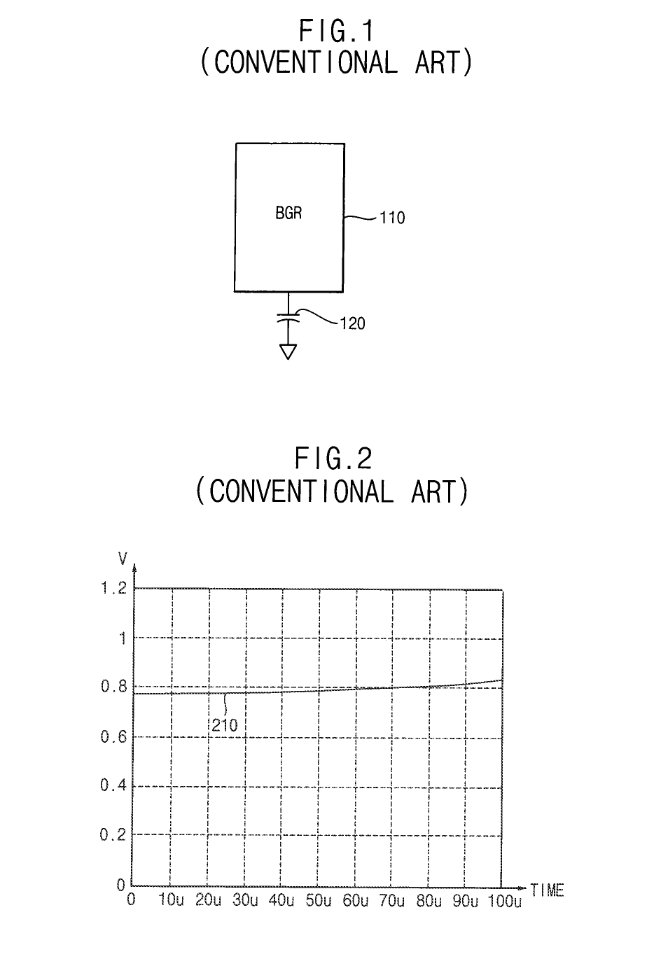

In FIG. 4, the reference voltage 410 generated from the reference voltage generator 300 of FIG. 3, unlike the reference voltage 210 generated from the reference voltage generator 110 of FIG. 1, may reach a target reference voltage (e.g., 1.2 V) within about 100 micro seconds from a reference voltage generation start time.

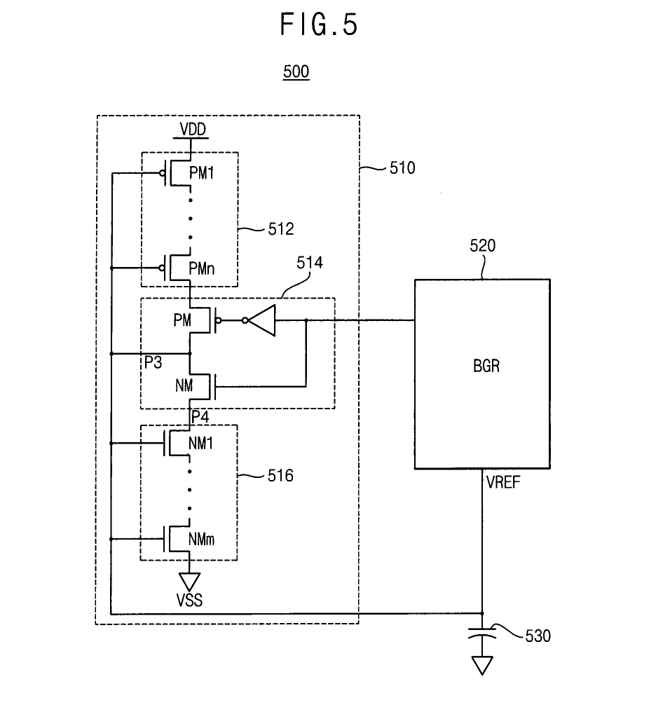

FIG. 5 is a circuit diagram illustrating a reference voltage generator in accordance with another example embodiment of the present invention. Referring to FIG. 5, a reference voltage generator 500 includes a start-up circuit 510 and a BGR circuit 520. The reference voltage generator 500 may apply a reference voltage to a load 530.

In one example embodiment, the load 530 may correspond to an output load employed in the reference voltage generator 500. In another example embodiment, the load 530 may be employed in a semiconductor device to which the reference voltage is provided. As occasion demands, the load 530 may be a capacitive element.

The BGR circuit 520 may supply the reference voltage to the load 530. According to the present invention, the BGR circuit 520 may provide a start-up signal to the start-up circuit 510 so that the reference voltage may rapidly reach the target reference voltage.

In some example embodiments, the BGR circuit 520 may generate the start-up signal when a voltage difference between the reference voltage and the target reference voltage is larger than a predetermined value.

In other example embodiments, the BGR circuit 520 may generate the start-up signal when the BGR circuit 520 starts or when a mode of the BGR circuit 520 is changed from a sleep mode to an active mode.

To reduce a time for the reference voltage provided from the BGR circuit 520 to approach the target reference voltage, the start-up circuit 510 may provide a boosting current into the load 530 substantially in proportion to the voltage difference between the reference voltage and the target reference voltage based on the start-up signal so that the start-up circuit 510 may increase the reference voltage provided from the BGR circuit 520.

The start-up circuit 510 may provide a first path P3 and a second path P4 for the boosting current. For example, the boosting current may be provided by the start-up circuit 510 into the load 530 through the first path P3. Further, the start-up circuit 510 may provide the boosting current into a current sink 516 through the second path P4. That is, the boosting current may be provided from the start-up circuit 510 through at least one of the first path P3 and the second path P4 in accordance with the difference between the reference voltage provided from the BGR circuit 520 and the target reference voltage.

In some example embodiments, the boosting current may be provided into the load 530 while the start-up signal is activated. Hence, the first path P3 for transferring the boosting current may be floated when the start-up signal is not activated.

The start-up circuit 510 may provide some portion of the boosting current through the first path P3 substantially in proportion to the difference between the reference voltage and the target reference voltage, whereas the start-up circuit 510 may provide another portion of the boosting current through the second path P4 substantially in reverse proportion to the difference between the reference voltage and the target reference voltage. When the difference between the reference voltage and the target reference voltage is relatively large, the start-up circuit 510 may mainly provide the boosting current through the first path P3 rather than the second path P4. Conversely, the start-up circuit 510 may mainly provide the boosting current through the second path P4 rather than the first path P3 when the difference between the reference voltage and the target reference voltage is relatively small.

In some example embodiments, the start-up circuit 510 includes a current source 512, a switch 514 and a current sink 516. The switch 514 may form the first path P3 and/or the second path P4 for transferring the boosting current into the load 530 and/or the current sink 516 based on the start-up signal generated from the BGR circuit 520. The boosting current may be provided to the load 530 and the current sink 516 through the first path P3 and the second path P4, respectively. In example embodiments, the switch 514 may include a transistor having a first conductive type or a transistor having a second conductive type.

The current source 512 may generate the boosting current. The boosting current generated by the current source 512 may be provided to the load 530 substantially in proportion to the difference between the reference voltage and the target reference voltage. The current source 512 may include at least one PMOS transistor PM1 through PMn having a gate to which the reference voltage is applied. In one example embodiment, the PMOS transistors PM1 through PMn included in the current source 512 may be connected in serial. In another example embodiment, the PMOS transistors PM1 through PMn included in the current source 512 may be connected in parallel. In some example embodiments, the current source 512 may include first through n-th PMOS transistors PM1 through PMn coupled to a power supply voltage VDD.

The current sink 516 may sink the boosting current into a ground voltage VSS substantially in reverse proportion to the difference between the reference voltage and the target reference voltage. The current sink 516 may include at least one NMOS transistor NM1 through NMn having a gate to which the reference voltage provided from the BGR circuit 520 is applied. In one example embodiment, the NMOS transistors NM1 through NMn included in the current sink 516 may be connected in serial. In another example embodiment, the NMOS transistors NM1 through NMn included in the current sink 516 may be connected in parallel. In some example embodiments, the current sink 516 may include first through n-th NMOS transistors NM1 through NMn coupled to the ground voltage VSS.

The current source 512 and the current sink 516 may increase the boosting current provided to the load 530 when the difference between the reference voltage and the target reference voltage is relatively large, and may decrease the boosting current provided to the load 530 when the difference between the reference voltage and the target reference voltage is relatively small.

In some example embodiments, the start-up circuit 510 may determine an amount of the boosting current provided to the load 530 and an amount of the boosting current sunk by the current sink 516 based on the number and sizes of the PMOS transistors PM1 through PMn and the number and sizes of the NMOS transistors NM1 trough NMn.

Alternatively, in some example embodiments, the transistors included in the current source 512, the switch 514 and the current sink 516 may be arranged in many different forms.

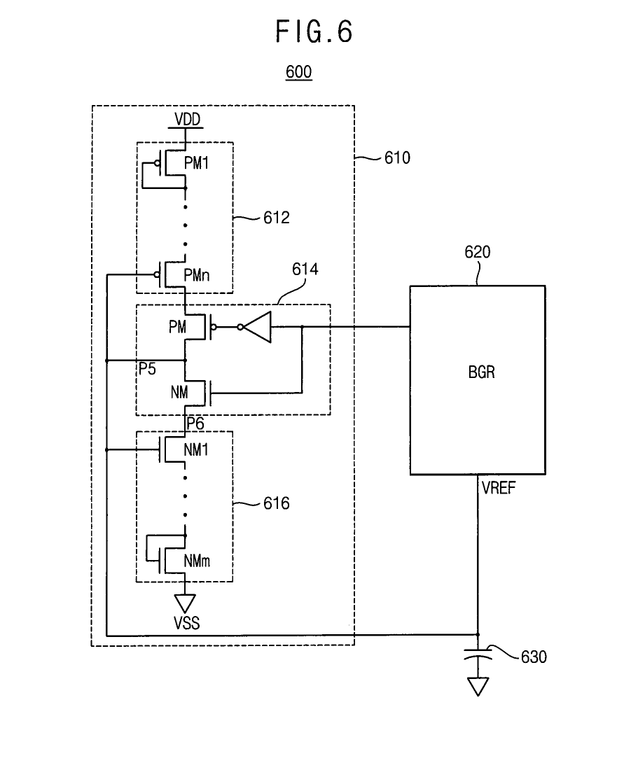

FIG. 6 is a circuit diagram illustrating a reference voltage generator in accordance with another example embodiment of the present invention. Referring to FIG. 6, a reference voltage generator 600 includes a start-up circuit 610 and a BGR circuit 620. The reference voltage generator 600 may apply a reference voltage to a load 630.

In one example embodiment, the load 630 may correspond to an output load employed in the reference voltage generator 600. In another example embodiment, the load 630 may be employed in a semiconductor device to which the reference voltage is provided. As occasion demands, the load 630 may be a capacitive element.

The BGR circuit 620 may supply the reference voltage to the load 630. According to the present invention, the BGR circuit 620 may provide a start-up signal to the start-up circuit 610 so that the reference voltage may rapidly reach the target reference voltage.

In some example embodiments, the BGR circuit 620 may generate the start-up signal when a voltage difference between the reference voltage and the target reference voltage is larger than a predetermined value.

In other example embodiments, the BGR circuit 620 may generate the start-up signal when the BGR circuit 620 starts or when a mode of the BGR circuit 620 is changed from a sleep mode to an active mode.

To reduce a time for the reference voltage provided from the BGR circuit 620 to approach the target reference voltage, the start-up circuit 610 may provide a boosting current into the load 630 substantially in proportion to the voltage difference between the reference voltage and the target reference voltage based on the start-up signal so that the start-up circuit 610 may increase the reference voltage provided from the BGR circuit 620.

The start-up circuit 610 may provide a first path P5 and a second path P6 with the boosting current. For example, the boosting current may be provided by the start-up circuit 610 into the load 630 through the first path P5. Further, the start-up circuit 610 may provide the boosting current into a current sink 616 through the second path P6. That is, the boosting current may be provided from the start-up circuit 610 through at least one of the first path P5 and the second path P6 in accordance with the difference between the reference voltage and the target reference voltage.

In some example embodiments, the boosting current may be provided into the load 630 while the start-up signal is activated. Hence, the first path P5 for transferring the boosting current may be floated when the start-up signal is not activated.

The start-up circuit 610 may provide some portion of the boosting current through the first path P5 substantially in proportion to the difference between the reference voltage and the target reference voltage, whereas the start-up circuit 610 may provide another portion of the boosting current through the second path P6 substantially in reverse proportion to the difference between the reference voltage and the target reference voltage. When the difference between the reference voltage and the target reference voltage is relatively large, the start-up circuit 610 may mainly provide the boosting current through the first path P5 rather than the second path P6. Conversely, the start-up circuit 610 may mainly provide the boosting current through the second path P6 rather than the first path P5 when the difference between the reference voltage and the target reference voltage is relatively small.

In some example embodiments, the start-up circuit 610 includes a current source 612, a switch 614 and a current sink 616. The switch 614 may form the first path P5 and/or the second path P6 for transferring the boosting current into the load 630 and/or the current sink 616 based on the start-up signal generated from the BGR circuit 620. The boosting current may be provided to the load 630 and the current sink 616 through the first path P5 and the second path P6, respectively. In example embodiments, the switch 614 may include a transistor having a first conductive type or a transistor having a second conductive type.

The current source 612 may generate the boosting current. The boosting current generated by the current source 612 may be provided to the load 630 substantially in proportion to the difference between the reference voltage and the target reference voltage. The current source 612 may include at least one PMOS transistor PMn having a gate to which the reference voltage provided from the BGR circuit 520 is applied and at least one diode-connected PMOS transistor PM1 serially connected to the at least one PMOS transistor PMn. In one example embodiment, the PMOS transistors PM1 through PMn included in the current source 612 may be connected in serial. In another example embodiment, the PMOS transistors PM1 through PMn included in the current source 612 may be connected in parallel.

The current sink 616 may sink the boosting current into a ground voltage VSS substantially in reverse proportion to the difference between the reference voltage and the target reference voltage. The current sink 616 may include at least one NMOS transistor NM1 having a gate to which the reference voltage provided from the BGR circuit 620 is applied and at least one diode-connected NMOS transistor NMn serially connected to the at least one NMOS transistor NM1. In one example embodiment, the NMOS transistors NM1 through NMn included in the current sink 616 may be connected in serial. In another example embodiment, the NMOS transistors NM1 through NMn included in the current sink 616 may be connected in parallel.

The current source 612 and the current sink 616 may increase the boosting current provided to the load 630 when the difference between the reference voltage and the target reference voltage is relatively large, and may decrease the boosting current provided to the load 630 when the difference between the reference voltage and the target reference voltage is relatively small.

In some example embodiments, the start-up circuit 610 may determine an amount of the boosting current provided to the load 630 and an amount of the boosting current sunk by the current sink 616 based on the number and sizes of the PMOS transistors PM1 through PMn and the number and sizes of the NMOS transistors NM1 trough NMn.

In some example embodiments, the diode-connected PMOS transistor PM1 may be located anywhere in the current source 612, and the diode-connected NMOS transistor NMn may be located anywhere in the current sink 614.

Alternatively, in some example embodiments, the transistors included in the current source 612, the switch 614 and the current sink 616 may be arranged in many different forms.

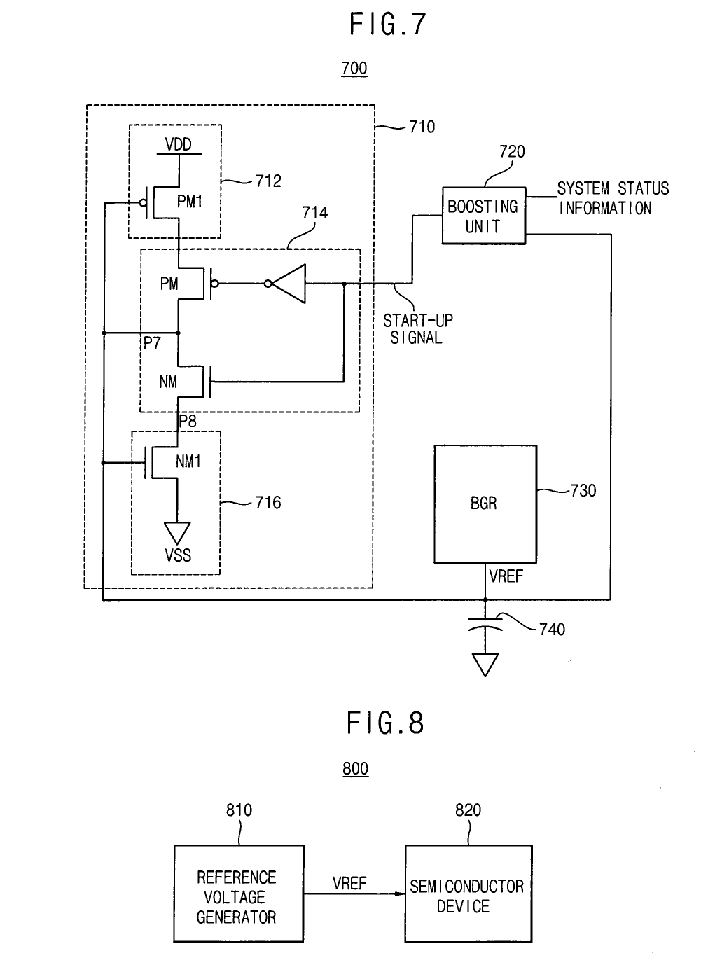

FIG. 7 is a circuit diagram illustrating a reference voltage generator in accordance with example embodiments of the present invention. Referring to FIG. 7, a reference voltage generator 700 includes a start-up circuit 710, a boosting unit 720 and a BGR circuit 730. The reference voltage generator 700 may apply a reference voltage to a load 740. In some example embodiments, the boosting unit 720 may be included in the BGR circuit 730.

In one example embodiment, the load 740 may correspond to an output load employed in the reference voltage generator 700. In another example embodiment, the load 740 may be employed in a semiconductor device to which the reference voltage is provided. As occasion demands, the load 740 may be a capacitive element.

The BGR circuit 730 may supply the reference voltage to the load 740. According to the present invention, the boosting unit 720 may provide a start-up signal to the start-up circuit 710 so that the reference voltage may rapidly reach the target reference voltage.

The boosting unit 720 generates the start-up signal based on system status information and the reference voltage. In some example embodiments, the boosting unit 720 may generate the start-up signal when the system status information is input and a voltage difference between the reference voltage and the target reference voltage is larger than a predetermined value. The system status information may include information on when the BGR circuit 730 starts, or on when a mode of the BGR circuit 730 is changed from a sleep mode to an active mode.

To reduce a time for the reference voltage provided from the BGR circuit 730 to approach the target reference voltage, the start-up circuit 710 may provide a boosting current into the load 740 substantially in proportion to the voltage difference between the reference voltage and the target reference voltage based on the start-up signal so that the start-up circuit 710 may increase the reference voltage provided from the BGR circuit 730.

The start-up circuit 710 may provide a first path P7 and a second path P8 for the boosting current. For example, the boosting current may be provided by the start-up circuit 710 into the load 740 through the first path P7. Further, the start-up circuit 710 may provide the boosting current into a current sink 716 through the second path P8. That is, the boosting current may be provided from the start-up circuit 710 through at least one of the first path P7 and the second path P8 in accordance with the difference between the reference voltage and the target reference voltage.

In some example embodiments, the boosting current may be provided into the load 740 only while the start-up signal is activated. Hence, the first path P7 for transferring the boosting current may be floated when the start-up signal is not activated.

The start-up circuit 710 may provide some portion of the boosting current through the first path P7 substantially in proportion to the difference between the reference voltage and the target reference voltage, whereas the start-up circuit 710 may provide another portion of the boosting current through the second path P8 substantially in reverse proportion to the difference between the reference voltage and the target reference voltage. When the difference between the reference voltage and the target reference voltage is relatively large, the start-up circuit 710 may mainly provide the boosting current through the first path P7 rather than the second path P8. Conversely, the start-up circuit 710 may mainly provide the boosting current through the second path P8 rather than the first path P7 when the difference between the reference voltage and the target reference voltage is relatively small.

In some example embodiments, the start-up circuit 710 may correspond to one of the start-up circuits 310, 510 and 610 illustrated in FIGS. 3, 5 and 6.

FIG. 8 is a block diagram illustrating an integrated circuit including a reference voltage generator in accordance with example embodiments of the present invention. Referring to FIG. 8, an integrated circuit 800 includes a reference voltage generator 810 and a semiconductor device 820.

The reference voltage generator 810 generates a target reference voltage. The semiconductor device 820 may perform specific operations based on the target reference voltage generated by the reference voltage generator 810.

In some example embodiments, the specific operations performed by the semiconductor device 820 may include any operations requiring the target reference voltage. For example, the semiconductor device 820 may perform at least one of the specific operations, such as a comparison operation, an operation of converting a digital signal to an analog signal, an operation of converting an analog signal to a digital signal, or an operation requiring a bias voltage, etc.

The reference voltage generator 810 may be implemented as one of the reference voltage generators 300, 500, 600 and 700 illustrated in FIGS. 3, 5, 6 and 7. As described above, the reference voltage generator according to some example embodiments of the present invention may provide a target reference voltage within a predetermined time using a boosting current if necessary.

Further, the reference voltage generator according to some example embodiments of the present invention may not provide the boosting current when the reference voltage reaches the target reference voltage so that power consumption may be reduced.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A reference voltage generator, comprising:
a band gap reference circuit configured to provide a reference voltage to a load; and
a start-up circuit configured to increase the provided reference voltage by providing a boosting current to the load based on a difference between the provided reference voltage and a target reference voltage.

2. The reference voltage generator of claim 1, wherein the boosting current is provided responsive to a start-up signal.

3. The reference voltage generator of claim 2, wherein the band gap reference circuit is configured to generate the start-up signal responsive to the difference between the provided reference voltage and the target reference voltage required by the load being larger than a predetermined value, thereby reducing a time in which the provided reference voltage reaches the target reference voltage.

4. The reference voltage generator of claim 2, wherein the band gap reference circuit is configured to generate the start-up signal responsive to one of (a) the band gap reference circuit starting and (b) a mode of the band gap reference circuit changing from a sleep mode to an active mode.

5. The reference voltage generator of claim 1, wherein the start-up circuit is configured to form a first path to provide the boosting current to the load, and a second path to sink the boosting current, the boosting current configured to flow through at least one of the first path and the second path in accordance with the difference between the provided reference voltage and the target reference voltage.

6. The reference voltage generator of claim 5, wherein the start-up circuit is configured to apply the boosting current to the first path substantially in proportion to the difference between the provided reference voltage and the target reference voltage and to the second path substantially in reverse proportion to the difference between the provided reference voltage and the target reference voltage.

7. The reference voltage generator of claim 2, wherein the start-up circuit comprises:
a current source configured to generate the boosting current;
a current sink configured to sink the boosting current; and
a switch configured to form a first path through which the boosting current is provided to the load substantially in proportion to the difference between the provided reference voltage and the target reference voltage, and a second path through which the boosting current is sunk by the current sink substantially in reverse proportion to the difference between the provided reference voltage and the target reference voltage responsive to the start-up signal.

8. The reference voltage generator of claim 7, wherein the current source includes at least one first transistor having a first conductive type and the current sink includes at least one second transistor having a second conductive type.

9. The reference voltage generator of claim 8, wherein an amount of the boosting current provided to the load and an amount of the boosting current sunk by the current sink are determined based on at least one of (a) a number of the at least one first transistor, (b) a size of the at least one first transistor, (c) a number of the at least one second transistor, and (d) a size of the at least one second transistor.

10. The reference voltage generator of claim 7, wherein the current source includes at least one PMOS transistor having a gate to which the provided reference voltage is applied, and wherein the current sink includes at least one NMOS transistor having a gate to which the provided reference voltage is applied.

11. The reference voltage generator of claim 10, wherein the current source further includes at least one diode-connected PMOS transistor serially connected to the at least one PMOS transistor.

12. The reference voltage generator of claim 10, wherein the current sink further includes at least one diode-connected NMOS transistor serially connected to the at least one NMOS transistor.

13. The reference voltage generator of claim 10, wherein an amount of the boosting current provided to the load and an amount of the boosting current sunk by the current sink are determined based on at least one of (a) a number of the at least one PMOS transistor, (b) a size of the at least one PMOS transistor, (c) a number of the at least one NMOS transistor, and (d) a size of the at least one NMOS transistor.

14. The reference voltage generator of claim 2, wherein the reference voltage generator further comprises a boosting unit configured to generate the start-up signal based on system status information and the provided reference voltage, and wherein the system status information includes information on at least one of (a) a first point in time when the band gap reference circuit starts and (b) a second point in time when a mode of the band gap reference circuit is changed from a sleep mode to an active mode.

15. The reference voltage generator of claim 14, wherein the boosting unit is configured to generate the start-up signal when the difference between the provided reference voltage and the target reference voltage required by the load is larger than a predetermined value.

16. The reference voltage generator of claim 14, wherein the start-up circuit is configured to form a first path to provide the boosting current to the load, and a second path to sink the boosting current, the boosting current being configured to flow through at least one of the first path and the second path in accordance with the difference between the provided reference voltage and the target reference voltage.

17. The reference voltage generator of claim 16, wherein the start-up circuit is configured to apply the boosting current to the first path substantially in proportion to the difference between the provided reference voltage and the target reference voltage, and to the second path substantially in reverse proportion to the difference between the provided reference voltage and the target reference voltage.

18. A reference voltage generator, comprising:
a band gap reference circuit configured to provide a reference voltage to a load; and
a start-up circuit configured to increase the reference voltage by providing a boosting current to the load based on a difference between the provided reference voltage and a target reference voltage, wherein the start-up circuit comprises:
a current source configured to generate the boosting current;
a current sink configured to sink the boosting current; AND
a switch configured to form a first path through which the boosting current is provided to the load substantially in proportion to the difference between the provided reference voltage and the target reference voltage, and a second path through which the boosting current is sunk by the current sink substantially in reverse proportion to the difference between the provided reference voltage and the target reference voltage; and
a boosting unit configured to generate a start-up signal based on system status information and the provided reference voltage.

19. An integrated circuit, comprising:
a semiconductor device configured to perform an operation based on a target reference voltage; and
a reference voltage generator configured to generate the target reference voltage, the reference voltage generator comprising:
a band gap reference circuit configured to provide a reference voltage to a load; and
a start-up circuit configured to increase the provided reference voltage by providing a boosting current to the load based on a difference between the provided reference voltage and the target reference voltage responsive to a start-up signal, thereby reducing a time in which the provided reference voltage reaches the target reference voltage.

20. The reference voltage generator of claim 19, wherein the operation includes at least one of (a) a comparison operation, (b) an operation to convert a digital signal to an analog signal, (c) an operation to convert the analog signal to the digital signal, and (d) an operation that requires a bias voltage.
